(19) United States
(12) Patent Application Publication
(10) Pub. No.: US 2006/0057022 A1
(43) Pub. Date: Mar. 16, 2006

(54) Food quality indicator

(76) Inventors: John R. Williams, Lexington, MA (US); Kathleen E. Myers, Newton, MA (US); Megan M. Owens, Waltham, MA (US); Marco A. Bonne, Carlisle, MA (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 11/225,410

(22) Filed: Sep. 13, 2005

Related U.S. Application Data
(60) Provisional application No. 60/609,306, filed on Sep. 13, 2004.
(60) Provisional application No. 60/615,884, filed on Oct. 4, 2004.

(51) Int. Cl. G01N 31/22

(52) U.S. Cl. 422/56; 436/1

(57) ABSTRACT

2 The invention generally relates to food quality indicators and, more particularly, to improved adhesive food quality indicators and their use and manufacture. The food quality indicators (FQI) of the invention are advantageously simple and low cost but sensitive devices for detecting unhealthy levels of food spoilage products in a sealed food product package. The FQI is affixed to a breathable or gas-permeable wrap around the product, and a visual indicator region in the FQI that is sensitive to the presence of food breakdown products allows the end user, by visual observation to determine whether microbial spoilage has occurred.

### RELATED APPLICATIONS

This application claims the benefit of priority under 35 U.S.C. 119(e) to copending U.S. Provisional Application Ser. Nos. 60/609,306, filed on Sep. 13, 2004; and 60/615,884, filed on Oct. 4, 2004, the entire contents of which are incorporated herein by reference.

### FIELD OF THE INVENTION

The invention generally relates to determining food quality, and more particularly, to

food quality indicators (FQIs) and methods for detecting microbial food spoilage.

### BACKGROUND OF THE INVENTION

Many articles of commerce such as food are perishable. When the perishable article is enclosed in packaging, it may not be readily apparent when the article has exceeded its useful lifetime.

For the person monitoring the package contents' quality, the food quality indicator (FQI) must not only accurately measure the condition of the food (which includes spoilable beverages) in the packaging, but the indicator must be easy to read and interpret. Several kinds of FQI labels are available, e.g., color-indicating label-type indicators which sense the degree of food degradation, but new indicators are needed.

Perishable food spoilage is an ever-present problem for the consumer, producer and seller. Although some deterioration in freshness is due to oxidative processes, spoilage is largely due to the growth of microbes such as bacteria, yeasts, and fungi. Microbes break down food carbohydrates, proteins and fats to derive energy for their growth. The breakdown process produces a variety of low molecular weight molecules such as carboxylic acids like lactic and acetic acids; aldehydes; alcohols; nitrogen-containing molecules like ammonia, trimethylamine, urea and diamines; and sulfur compounds.

Spoilage has historically been monitored by standard bacteriological and chemical laboratory methods. These analytical methods are obviously outside the reach or desire of consumers, who simply wish to know in most cases whether the food is “good” or “bad.” So, consumers rely on the time-tested smell, color or taste tests, all of which leave open the possibility that food, e.g., meat, which “looks” or “smells” good may in fact be not good.

### SUMMARY OF THE INVENTION

A more precise, simple, reliable and convenient means of determining the quality of packaged food is provided by the present invention. The invention relates to food quality indicators (FQI) in the form of a label that can be affixed inside any clear food packaging or outside a breathable or gas-permeable food packaging and read by anyone to determine the quality of the packaged food.

The invention in one embodiment relates to an FQI containing a material whose color changes as a function of food quality, i.e., in response to a food breakdown product, and a means of attaching it to a preferably breathable or gas-permeable food package, container or wrapping. An anti-leachant may be provided in the region containing the color-changing agent to prevent liquids from leaching the agent; alternately or additionally, the FQI may include a removable or fixed (breathable) membrane or barrier material over the indicator region to accomplish the same thing.

In a desirable embodiment, an FQI is provided which includes, in turn, an impervious layer having at least one non-impervious region, a porous substrate layer having at least one region containing an indicator composition which changes color in response to compounds characteristic of decomposing food, and an adhesive layer having at least one breathable or non-adhesive region, wherein at least one non-impervious region(s), the indicator region(s) and one breathable or non-adhesive region overlay each other to form an indicator region allowing for fluid communication across the porous substrate, which indicator region allows for visual indication of the state of spoilage. The FQI may further include a release sheet adhering to the adhesive layer to protect the adhesive from unintended use and to also allow the use of label application equipment.

The invention also provides a method of monitoring food quality in a sealed package, including the steps of providing a food package containing a food product; and a breathable or gas-permeable wrap, affixing an FQI to the wrap, wherein the FQI includes an impervious layer having at least one non-impervious region; a porous substrate layer having at least one region containing an indicator composition which changes color in response to compounds characteristic of decomposing food; and an adhesive layer having at least one breathable or non-adhesive region, wherein at least one non-impervious region(s), the indicator region(s) and breathable or non-adhesive region overlay each other to form an indicator region allowing for fluid communication across the porous substrate, which indicator region allows for visual indication of the state of spoilage, and visually inspecting the FQI to determine the quality of the food product based on the color of the FQI. In one embodiment of the method of monitoring food quality in a sealed package, the visual inspection step further includes comparing the color of the FQI in reference to a color region displayed on the impervious layer.

The invention also provides a method of manufacturing a laminated FQI including providing a porous substrate layer, laminating an adhesive pattern to one surface of the porous substrate layer, where the pattern includes regions where adhesive is not applied or is breathable, providing an impervious layer for lamination to the non-adhesive surface of the porous substrate layer, the impervious layer having at least one non-impervious region, laminating an impervious layer to the non-adhesive surface of the porous substrate layer so the non-impervious region(s) are situated over the non-adhesive regions of the porous substrate layer as laminated above, applying to the non-adhesive region(s) of the porous substrate layer an indicator composition which changes color in response to compounds characteristic of decomposing food and laminating a release sheet to the patterned adhesive surface of the porous substrate layer.

Other features and aspects of the invention will be apparent from the Detailed Description of The Invention, and the included Drawings.

### BRIEF DESCRIPTION OF THE DRAWINGS

FIG. 1 is a schematic showing top views of FQIs according to the invention with a reference region appearing adjacent to the FQI material.

FIG. 2 is a schematic showing a side view of an FQI according to the invention with a circle or ellipse cut through the layers excepting the porous substrate layer.

FIG. 3 is a pictorial illustrating an FQI according to the invention as an end user would view it on the packaging.

FIG. 4 is a pictorial illustrating a “new” (FIG. 4A) and “used” (FIG. 4B) FQI according to the invention as an end user would view it on the packaging.

FIG. 5 is another pictorial illustrating a “new” (FIG. 5A) and “used” (FIG. 5B) FQI according to the invention as an end user would view it on the packaging.

FIG. 6 is a pictorial of another FQI of the invention, showing the progression of the FQI in use, illustrating the FQI on “fresh” food (FIG. 6A) and “non-assured” quality food (FIG. 6B) and food that should be discarded (FIG. 6C.)

FIG. 7 is a pictorial illustrating a different embodiment of the invention of FIG. 6, where a bar-type comparative display is used instead of the encircled reference “Q” area.

### DETAILED DESCRIPTION OF THE INVENTION

The features and other details of the invention will now be more particularly described. It will be understood that particular embodiments described herein are shown by way of illustration and not as limitations of the invention. The principal features of this invention can be employed in various embodiments without departing from the scope of the invention.

Definitions

For convenience, certain terms used in the specification, examples, and appended claims are collected here.

“Impervious” layer is intended to include or refer to materials, e.g., sheet materials, which are completely or substantially impervious or impermeable to common household or environmental contaminants, such as water, water vapor, hand oils, dust, gases, food decomposition products or other vapors, etc. A “non-impervious” area or region will have the inverse meaning.

“Porous” materials include those having a continuous, discontinuous, structured or random structure having channels or pores, which allow for the absorption, adsorption or attachment of an indicator composition thereto, and which allow for fluid communication across uncoated portions thereof.

“Breathable” or “gas-permeable” may be used interchangeably, and refer to materials allowing for selective or non-selective exchange of gases or vapors.

As noted above the invention broadly relates to FQIs containing a material whose color changes as a function of food quality, i.e., in response to a food breakdown product, and a means of attaching it to a preferably breathable or gas-permeable food package, container or wrapping. The FQI is desirably in the form of an easily applicable label which may be affixed to the inside or outside of a wrapped food product.

One desirable embodiment of the invention is an FQI which includes an impervious layer having at least one non-impervious region, a porous substrate layer having at least one region containing an indicator composition which changes color in response to compounds characteristic of decomposing food, and an adhesive layer having at least one breathable or non-adhesive region, wherein at least one non-impervious region(s), the indicator region(s) and breathable or non-adhesive region overlay each other to form an indicator region allowing for fluid communication across the porous substrate, which indicator region allows for visual indication of the state of spoilage. Desirably, a release sheet adhering to the patterned adhesive layer to protect the adhesive from unintended use is included.

The porous substrate layer may be made of any porous material onto or into which an indicator composition may be applied. The porous substrate is desirably as “inert” as possible, i.e., one which does not adversely impact the stability of the indicator composition, or its color, especially over time (in the absence of reactants which change the color of course.) The porous substrate layer desirably is pH balanced so as not to change the color of the indicator composition; in one embodiment the pH of the porous substrate layer is between 6 and 8, desirably less than 7, and desirably between 6 and 7.

One example of a porous substrate layer is a layer of paper on which the FQI material is applied. This paper can be filter paper made of 100% cellulose, e.g., Millipore FP102, or Phase Separation (PS) filter paper (Whatman, Inc., Clifton, N.J.). The porous substrate layer may also be constructed from plastic (e.g., polyester, polyethylene, polyvinyl chloride), or any other polymeric membrane, cotton, flax, resin, glass, fiber glass, or fabric.

The indicator composition may be any material that is able to detect spoilage in a food product. These compounds are capable of colorimetrically indicating the presence of one or more chemical compounds associated with the decomposition or spoilage of food. There are a number of chemical compounds that are generated as food decomposes and spoils (i.e., “spoilage products”.) Many foods that contain substantial amounts of protein materials, including red meat, pork, poultry, processed meat, and seafood products, generate volatile compounds, such as volatile bases, during decomposition.

Amines, e.g., compounds bearing one or more NH₂ groups (e.g., amines, diamines, triamines, aromatic, heterocyclic or aliphatic amines), are one group of volatile bases generated by decomposing food, e.g., via deamination of free amino acids and the degradation of nucleotides. For example, proteins are generated from amino acids; when proteins are bacterially decomposed, they are converted to amines related to these amino acids. The amino acid arginine is converted to putrescine, lysine to cadaverine, and histidine to histamine. Putrescine, cadaverine and histamine are responsible for the smell of rotting protein such as meat and seafood, and the levels of these amines reflect the degree of bacterial decomposition. Among other amines generated are ammonia, dimethylamine, and trimethylamine. These compounds may also volatilize. Other amines associated with decomposing food include indoles, spermine, and spermidine.

Indicator compounds of the invention, in one embodiment, change colors in the presence of these volatile bases. The particular range of concentrations of volatile bases that will cause a color change of the indicator compound depends on factors such as the particular indicator compound used in the device, the chemical environment in which the indicator compound is placed (e.g., the acidity or basicity of the environment), and the amount of indicator that is used in the device. The appropriate range can be determined for each food product by, for example, calibration with test samples. It is expected that different food products will produce different amounts of volatile bases when spoiled. However, food products that are similar (e.g., different types of fish) may generate similar amounts of volatile bases.

The range of concentrations of generated volatile bases that cause a color change in the indicator compound may be chosen to indicate a variety of conditions. For example, the color change may indicate that the food is unsafe for consumption or that the food will soon become unfit for consumption.

The presence of an unwanted amine-producing biological agent, such as bacteria, mold or fungus, may be detected instead of or in addition to food decomposition. A color change of the indicator compound may indicate the presence of an unwanted biological agent, such as bacteria, mold or fungi. For example, certain fungi generate amines when in contact with grains. Smut on unprocessed wheat stored in silos or in cargo holds of ships generates trimethylamine. Although, the invention is described herein with reference to the detection of food decomposition, it will be appreciated that the same devices, methods, and principles can be applied to the detection of unwanted biological agents. Ideal indicators are nontoxic and, preferably, can be used as food additives or dyes, thereby minimizing any danger that might occur if the indicator compound leaks from the FQI. The ideal indicators have a strong color change upon detection of the volatile bases and the color change is apparent even to color blind members of the population. Indicators without these particular characteristics may also be used, however.

Classes of suitable indicators include xanthene dyes, azo dyes, and hydroxy-functional triphenylmethane dyes. A number of these indicators contain phenol functionalities. Many suitable indicators are halogenated and/or contain acidic functional groups, such as —COOH, —SO₃, or —S(O₂)O— or salts thereof. Preferred indicators include halogenated xanthene dyes such as Phloxine B, Rose Bengal, or Erythrosine; sulfonated azo dyes such as Congo Red and Metanil Yellow; and sulfonated hydroxy-functional triphenylmethane dyes such as Bromophenol Blue, Bromocresol Green, and Phenol Red. The most preferred indicators for use with frozen seafood are Phloxine B, Rose Bengal, and Bromophenol Blue. In preferred embodiments, the invention utilizes one or more indicators comprising or derived from naturally occurring compounds such as betalains (which include betanidin, betacyanins, and betaxanthins) and/or flavonoids (which include anthocyanins and anthocyanidins) as detection chromophores; these compounds undergo a color change in the presence of amine compounds, and this color change is employed as an indicator of food quality. More generally, the detection material may be a betalain or a betalain derivative. Betalains suitable for use in connection with the present invention are red-violet betacyanins, and useful compounds include betanidin, betanin and their derivatives (e.g., betanin esters). Preferably, the FQI material is chosen from the list including cabbage powder extract, beet extract, anthocyanins, anthocyanidins, flavonoids, betalain and derivatives thereof.

Indicator compositions may include natural acid-base indicators such as those present in beets, cabbage, red wine, grapes, tea, blueberries, strawberries, and cranberries; or synthetic indicators such as crystal violet, cresol red, thymol blue, methyl orange, methyl red, eriochrome black, bromcresol purple, phenolphthalein, thymolphthalein, and mordant orange.

Betalains have the chemical formula

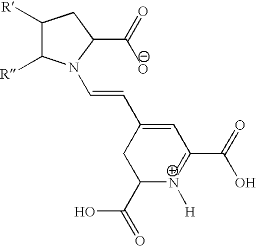

where R′═R″═OH for betanidin and, for betanin, R′═GlcO (Glc=glucose) and R″═OH. The identities of R′ and R″ are not critical to the invention, however, and may be hydrogen atoms or other substituents. The carboxyl groups are desirably esterified. For example, ester derivatives of betanin can be prepared by reaction with an alcohol in the presence of a strong acid, such as sulfuric acid:

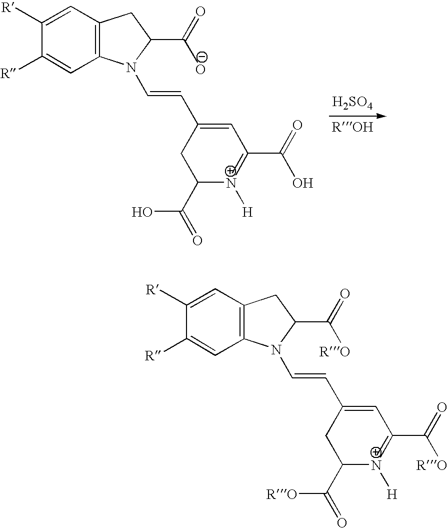

In preferred embodiments, R′ and R″ are OH, ester, alkyl, aryl, or mixed alkyl-aryl groups, or GlcO, and R′″ is an alkyl, aryl, or mixed alkyl-aryl group. To prevent gradual loss of indicator activity due to oxidation, it may be desirable to utilize R′ and R″ groups lacking moieties subject to oxidation. Antioxidants may also be employed in the formulation. In some embodiments, R′″ is an alkyl group having from one to 20 carbon atoms, and may be linear, branched, cyclic, or a combination thereof. In other embodiments, R′″ may be an aryl compound based, e.g., on aromatic rings having one, two or three members.

Flavonoids indicators suitable for use in the invention are red-violet compounds that accumulate naturally in flowers, fruits and some vegetables, most notably cabbage. Useful compounds include anthocyanin, anthocyanidin and their derivatives. These have the chemical formula:

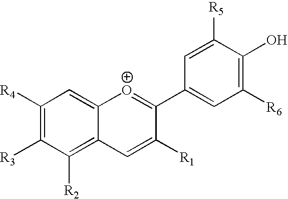

where R₁ is H, O-Sugar or OH, R₂ is OH, O-Sugar or OMe, R₃ is H or OH, R4 is H, O-Sugar, OH or OMe, R₅ is H, OH or OMe, and R₆ is H, O-Sugar, OH, OMe. “Sugar” includes monosaccharides, oligosaccharides or polysaccharides, e.g., glucose, sucrose, etc., or a derivative thereof. The flavonoid compound may be esterified, e.g., via acylation.

Betalain or flavonoid indicators are particularly suitable for use in the invention, since they may be safely brought into contact with food, and because even water-soluble betalains and flavonoids are retained in some porous substrates even after exposure to polar compounds such as water.

Suitable acid-base modulating agents may be added to the indicator compositions, including bicarbonates and their salts, carbonates and their salts, hydroxides (e.g., NaOH, KOH, and LiOH), ammonia and ammonium salts, biogenic amines and their salts, amines and their salts, amino acids and their salts, carboxylic acids and their salts, phosphoric acid and its salts, sulfuric acid and its salts, and boric acid and its salts. Preferably, the modulating agent is a base (e.g., hydroxide, bicarbonate, lysine, arginine, histidine or triethanolamine) when the desire is to have the indicator transition more quickly in response to amines. The opposite is true when the desire is to detect acid decomposition products. Preferably, the base is an alkali metal hydroxide such as NaOH. The sensitivity of the indicator compositions may also be altered by the use of co-pigments, concentration, combining indicators, surface area, and illumination. Preferably, the modulating agent is an acid when the desire is to have the indicator transition less quickly in response to amines or to increase the ‘before and after’ color contrast. Preferably, the acid is a non-volatile acid such as sulfuric acid. The opposite is true when the desire is to detect base decomposition products.

To prepare a suitable indicator solution, the amount of a base or an acid required to effect a color change is calculated based on reaction stoichiometry, and an aqueous solution of modulating agent is prepared with slightly less than the calculated amount of modulating agent. A porous substrate is dipped in the aqueous modulating agent solution and dried, then dipped in a non-aqueous detection material solution. The filter paper is now “tuned” for detection of low levels of amines. Alternately, the first solution may be non-aqueous, and the second solution is aqueous. In another embodiment, the indicator and modulator solutions are prepared using the same solvent and tuned to a pH slightly before that which effects a color change. The porous substrate is then dipped in the solution and used to detect low levels of contaminant.

To tune the solution for enhanced sensitivity, the detection material solution itself is titrated so that it has slightly less than the amount of a modulating agent needed to effect a color change. For example, untuned beet extract has a pH of about 4.6. Exposing the indicator composition impregnated with beet extract to a saturated headspace of 1,5-diaminopentane (cadaverine) requires about 4 days for a color change to occur. However, by tuning the beet extract to a pH between about 7.00 and 8.02, a rapid color change on the order of about 15 seconds is observed. Using a natural or edible substance like beet extract (or a component thereof, e.g., betanin) also eliminates the potential of spoiling or contaminating food with the indicator composition. By proper selection of the indicator composition and the modulating agent, an FQI may be made having an altered sensitivity corresponding to a detection threshold that is dependent on the type of food being screened. For example, different indicator compositions or different amounts of modulating agent may be selected based on the contaminant expected to be detected and/or the character of the food (e.g., the natural presence of some amines even in fresh seafood.) This permits rapid and meaningful detection of the contaminant of interest. The selection of the material/agent combination may be based on the contaminant, the food, or on the tolerance level for the contaminant.

For some foods and beverages, acid products are formed as the food spoils, e.g., lactose in milk is converted to lactic acid and ethanol in wine is converted to acetic acid (vinegar). The same indicators used to detect bases such as amines may be employed to detect acid degradation products, too. This may be accomplished either by utilizing an alternate transition point if one exists, or by adjusting the pH of the indicator to observe the reverse of the change observed for amines. In this way, the indicator system provides an ongoing visual indication of food quality.

The FQI material can be applied to the porous substrate layer in a discrete area or applied throughout the porous substrate layer. If the FQI material is applied on a discrete area, the area may be shaped as a circle, rectangle, triangle, or any other shape, as long as the area to which the food quality material is applied is large enough for the change in the indicator, due to the presence of spoiled food product, to be observed.

The indicator compound may also be held within a porous polymeric matrix to prevent leakage of the indicator compound into the food. The polymeric matrix may be adapted to clathrate the indicator compound. Suitable polymeric matrices are at least partially permeable to one or more of the volatile bases to be detected. In another approach, the indicator molecule is incorporated within a polymer matrix. This may be achieved by mixing the indicator with a prepolymer prior to reaction; polymerization entrains the indicator molecule within the polymer matrix, with sufficient surface exposure and/or polymer permeability to facilitate adequate interaction (leading to a visible color change) with food-generated amines. For example, a betalain or flavonoid indicator may be mixed with polystyrene, polyvinylidene chloride and polyvinyl chloride.

The matrix may be hydrophobic. A hydrophobic matrix prevents water from accessing the materials sequestered within the matrix, such as the detection material and/or the modulating agent, while permitting the contaminant to pass through and interact with the detection material. As a result, the hydrophobic nature preserves the useful life of the detection material. In various embodiments, the detection material and modulating agent combination is applied to a cloth, such as cheese cloth, to paper, or to a surface of a plastic. Alternatively, the detection material and modulating agent combination may be disposed within a gel or gelatin.

The invention generally relates to an FQI which, when applied to food packaging, monitors the freshness of food and detects spoilage. The FQI adheres attached to the food wrap or food container in such a way that it is able to detect spoilage of the food contained therein, e.g., via exposure to the indicator region by spoilage products within the wrap.

The FQIs of the invention include an impervious layer having at least one non-impervious region, a porous substrate layer having at least one region having the indicator composition, and an adhesive layer having at least one breathable or non-adhesive region. At least one of the non-impervious regions, indicator regions, and breathable or non-adhesive region overlay each other to form an indicator region allowing for fluid communication across the porous substrate. In this manner the indicator region also allows for visual indication of the state of spoilage. As it is contemplated that many applications will only require one small (e.g., 1-2 cm×2-4 cm) FQI on the food package, there will typically be only one indicator region. However, other applications may mandate monitoring more than one spoilage product, so there may be additional indicator regions with different indicator compositions within each, for accomplishing this.

In use, the adhesive layer permits affixing the FQI to the food packaging. While the device will work equally well inside or outside of the packaging, it is contemplated that in many cases the device will be affixed to the outside, for flexibility of use. In the “outside” application, the configuration of the device permits fluid communication from the inside of the food packaging (where volatile or non-volatile spoilage products will reside), through the breathable food packaging, and through the indicator region of the device, whereupon the indicator composition will change color in response to reaction with spoilage products.

The adhesive layer has at least one breathable or non-adhesive region to allow fluid communication through the indicator region, i.e., there is at least some pathway through the adhesive layer to allow the food breakdown products to traverse or contact the porous substrate containing the indicator composition. In an embodiment, the adhesive layer may be a patterned adhesive, e.g., alternating strips of adhesive and non-adhesive areas are laid down onto the porous substrate, leaving the non-adhesive areas for application of the indicator composition, which may be applied in a discrete area, or a strip. In another embodiment, the adhesive layer may be “printed” onto the porous substrate in a pattern, e.g., much like lithography, resulting in discrete adhesive dots or a grid of adhesive on the surface of the porous substrate, resulting in a large surface area of exposed porous substrate, but with the entire area of the porous substrate available to adhere to the wrap material beneath it. This embodiment allows for a little more flexibility in manufacture of the FQI in that the indicator region need not be aligned to a discrete region of the porous substrate. In this manner the “breathability” of the adhesive layer may also be adjusted if desired.

The adhesive layer may be made of any non-toxic adhesive which holds the FQI together, and to the food packaging, e.g., pressure-sensitive adhesives, acrylic-based adhesives and/or UV-cured adhesives. The adhesive in the adhesive layer may be applied evenly throughout the layer, or it may be applied in a patterned manner, with some parts of the adhesive layer not having adhesive applied to it. In a particular embodiment, a patterned adhesive layer does not place adhesive on the area in which the indicator material composition is located.

The impervious layer serves as a barrier to seal off all but the indicator region, thus defining the boundary of the indicator region and thus the channel for fluid communication. In one embodiment, the impervious materials used are fluid repellent, but allow the flow of amines. Examples of materials used in construction of impervious layers may include polyethylene, polypropylene, polyolefins, acrylics, silica sol-gels, silicone polymers including polydimethyl silicones, silane titanium oxide sol-gels, silane cross-linkable resins, polytetrafluoroethylene (e.g., TEFLON®), polyvinylchloride, polyester, treated/coated papers, and butylated cellulose.

The FQI desirably further includes a release sheet adhering to the patterned adhesive layer, to protect the adhesive from premature use and allowing the use of label application equipment.

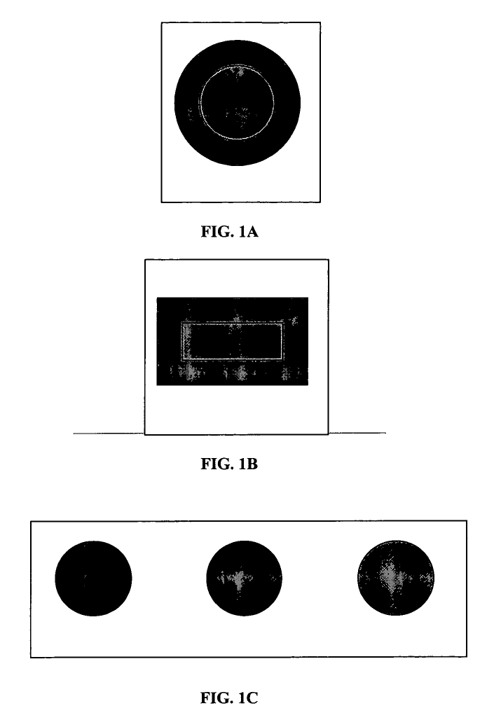

The FQI of the invention is arranged in layers. In one example of a label of the invention, the FQI material is applied to a discrete region of the porous substrate layer. For example, as shown in FIG. 1, the indicator composition is applied within a circle surrounded by a printed reference region having color of the FQI material when it is exposed to spoiled food. The adhesive layer, which affixes the FQI to the food packaging, is not applied in areas of the porous substrate layer which have indicator composition applied to it. There may be a first barrier layer between the boundary limited adhesive layer and the porous substrate layer. Optionally, the barrier layer is die-cut so that there is nothing between the porous substrate layer (to which the FQI material has been applied) and the food packaging. A label material layer (e.g., having the indicia thereupon) is disposed between the porous substrate layer and the impervious layer. Table 1 summarizes the structure of the above described FQI:

TABLE 1

Food packaging (transparent food wrap or food container)
or disposable liner
Adhesive
Barrier layer with die-cut opening
Adhesive
Porous substrate layer with indicator composition
Adhesive
Label material (impervious layer) with die-cut opening

Another example of the invention is one in which the porous substrate layer and adhesive layer are combined into a single layer. This may be achieved by applying the FQI material to one portion of the porous substrate/adhesive layer and applying the adhesive to the remaining portion(s) of the porous substrate/adhesive layer, i.e., “patterning”; or by applying the FQI material to a discrete portion of the layer, and applying the adhesive evenly across the whole layer; or by applying the FQI material and the adhesive evenly across the whole layer. On the side of the porous substrate/adhesive layer furthest from the food packaging is disposed the impervious label material layer. Table 2 summarizes the structure of this FQI:

TABLE 2

Food packaging
or disposable liner
Patterned adhesive
Porous substrate layer with indicator composition
Adhesive
Label material (impervious layer) with die-cut opening

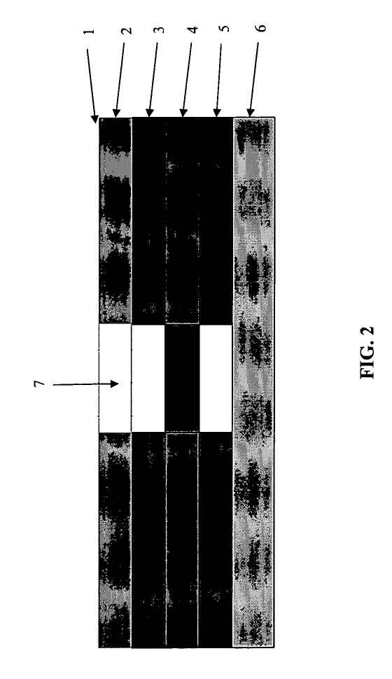

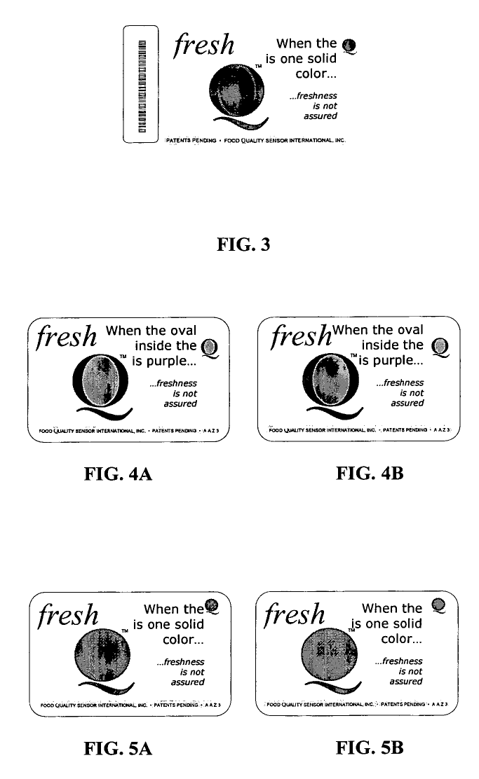

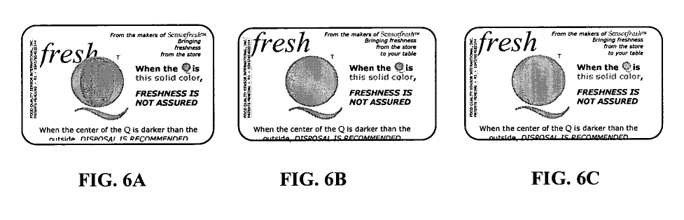

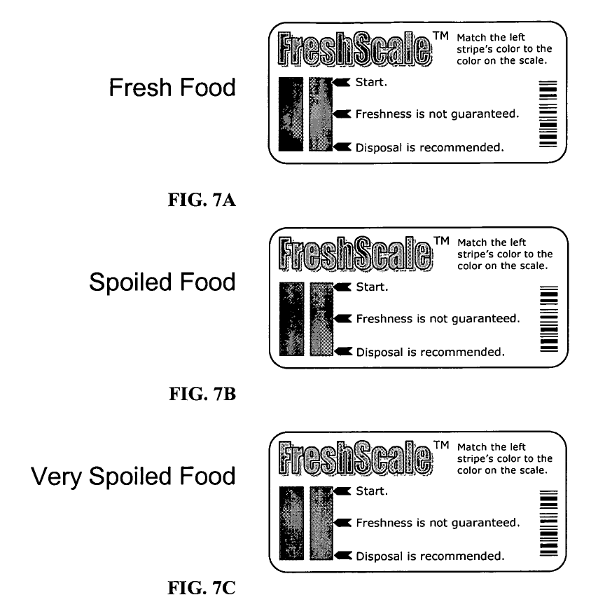

Another example of an FQI embodiment is depicted in FIG. 2. The FQI includes a release sheet 6. The release sheet 6 may display indicia showing that the FQI has not been activated. This allows the FQI to be stored until it is affixed to the packaging of a food product for monitoring and detection of spoilage. The FQI is easily peeled off of the release sheet 6 to be affixed to food packaging. The top layer 1 has indicia printed on it. The indicia may include artwork, text, instructions and/or reference material showing the color of the FQI material after exposure to spoiled food product. The artwork, text and reference material may be protected by a varnish, laminate, or other protection. This top layer, upon the top of which the label is made, may be a die cut polyethylene film 2. Under the impervious layer is an adhesive 3 used to hold the impervious layer to the porous substrate layer 4 below. The porous substrate layer 4 has the indicator composition applied in a discrete region. Below this is disposed the patterned adhesive 5 which holds the FQI to the release sheet 6 and when used, affixes the FQI to the food packaging. The FQI also has a die cut area 7 cut through the layers of the FQI except for the porous substrate layer 4. The die-cut area 7 allows fluid communication across the porous substrate layer.

The label material layer may have printed on it indicia including price, bar codes, instructions for interpreting the FQI, and/or a reference material. In particular, the reference material includes a colored area desirably placed adjacent to the indicator composition so it contrasts with the indicator color. The reference material is generally not placed on the same layer as the FQI material. A particularly desirable embodiment of the invention is depicted in FIG. 3. FIG. 3 shows a specific embodiment of the FQI of the invention. What is shown in the label material layer which is placed on the top of the FQI as shown in FIG. 2. This label material shows a bar code, and instructions on how the FQI operates. The label material layer, shown in FIG. 3, has a reference material in the shape of the letter “Q” formed around a window that shows the FQI material below. The “Q” is the color of the indicator material when it is exposed to spoiled food product, thus when the “Q” is one solid color, freshness is not assured.

In another embodiment, the FQI may be applied to any location on the outside of the food package (i.e. the top, side or bottom). A primary advantage of attaching the FQI to the outside of the packaging material is greater flexibility with respect to the timing of applying the indicator to the food package, i.e., it would not require the food packager to apply the label. The label could thus be applied by supermarket workers, truck drivers, shippers, etc. Customers may be also able to attach their own labels and/or indicator material. This would allow the customer to determine the freshness of the food as it is stored in the home and indicate to the customer that the food may either continue to be stored in the refrigerator, or that it must be used soon. In one embodiment, the label or indicator material may be attached to the outside of the packaging material after the packaging process is complete.

In this embodiment, the FQI may be in one of the configurations depicted above, but note that for the indicator to work properly, the outer wrap over which the label is affixed must be “breathable” or semipermeable to the food breakdown products being detected, to allow the food breakdown products to impinge on the FQI material; at the very least the outer wrap must be breathable or gas-permeable in the particular area over which the label is affixed. Examples of breathable or gas-permeable packaging materials include ethylene vinyl acetate, polyolefins (including polyethylene and polypropylene), polystyrene, polycarbonate, polytetrafluoroethylene, fluoropolymers, polymethylmethacrylate, acetal, polyvinylchloride, phenoxy, polyester, nylon, polyvinylidenefluoride, epoxy, polyvinylidenechloride and nitrites. These materials may be used as single layer films or may be used together as multilayered films.

In another embodiment, the FQI may optionally include a hydrophobic, gas-permeable, cover layer over the impervious layer to allow fluid communication across the porous substrate, but prevent it from the elements.

In another embodiment, the FQI may optionally include a removable hydrophobic cover layer over the impervious layer. In one aspect of this embodiment, the removable cover layer displays indicia showing that the device is not activated, and the impervious layer displays indicia showing that the device is activated, wherein the indicia on the impervious layer is at least partially invisible when the removable cover layer is in place. Another aspect of this embodiment includes a booklet or fold-out pamphlet containing instructions for use, or marketing or educational information, etc.

In another embodiment, the FQI may be attached during an intermediate stage of the packaging process (i.e. to an internal layer of a multi-layer packaging material). This ensures that the FQI becomes part of the food package and can not be easily removed which may be advantageous in preventing someone from tampering with the indicator.

The FQI is not limited in size or shape and may contain information both related and unrelated to the indicator. For example, it may contain color references and instructions for use and may contain a barcode, pricing, etc. The reference may be a non-indicating material having a different color or an indicating material hermetically sealed from the food environment. The reference may be any shape including a circle or rectangle adjacent to the active indicator or a circle within a larger circle or a line. FIG. 1A depicts an FQI with the indicator composition applied to a circular area within a circular reference area surrounding the indicator composition. When the color of the indicator composition matches the color of the reference, this indicates that the food inside the packaging has spoiled. In FIG. 1B, the area to which the indicator material and reference material are applied are rectangular.

Further, as shown in FIG. 1C, the reference material may be displayed completely separately from the FQI material, and there may be more than one reference material. FIG. 1C shows circles on the left and right showing the color of the indicator in the presence of low and high bacterial levels, respectively. The FQI material is shown as the middle circle. This allows one to see gradations of spoilage as microbial organisms become more prevalent on the food product being monitored.

The invention also encompasses a food package containing a food product, a gas-permeable wrap enclosing the food product, and an FQI affixed to the gas-permeable wrap, wherein the FQI comprises an impervious layer having at least one non-impervious region; a porous substrate layer having at least one region containing an indicator composition which changes color in response to compounds characteristic of decomposing food; and a patterned adhesive layer having at least one adhesive region and at least one non-adhesive region, wherein at least one non-impervious region(s), the indicator region(s) and the non-adhesive region overlay each other to form an indicator region allowing for fluid communication across the porous substrate, which indicator region allows for visual indication of the state of spoilage.

An exemplary and non-limiting method of making FQIs in accordance with the invention is described below.

Step 1: Paper Lamination to Liner and Indicator Deposition.

a) Adhesive coat a liner material (paper or film with release agent), leaving stripes of uncoated adhesive.
b) Laminate porous substrate, e.g., a cellulose-based paper, to the structure made in step 1a, creating a structure consisting of paper, patterned adhesive, release agent and liner. (When the label is used, the liner is peeled away and the adhesive remains on the porous substrate.)
c) Spray or print the indicator composition-containing solution in the non-adhesive areas of 1b.
d) The resulting structure consists of paper with an indicator stripe, patterned adhesive (i.e., no adhesive in the indicator stripe areas), release agent and liner.
   Step 2: Preparation of Impervious Layer with Indicia.
a) Print all indicia, instructions, etc. one color at a time on a impervious layer material consisting of polyethylene, acrylic adhesive, release agent and glassine liner.
b) Die cut an area, e.g., a circle or ellipse in the center of a printed “Q” in the structure of 2a;
c) The resulting structure consists of all printing/indicia, polyethylene, acrylic adhesive, release agent and glassine liner with a die cut hole in the center of the Q.
   Step 3: Merging Structures 1 and 2
a) Taking the structure of 1c, delaminate the release agent and glassine liner from the remaining structure consisting of printing/indicia, polyethylene, acrylic adhesive with a die cut hole in the center of the Q. Discard release agent/glassine liner.
b) Laminate the structure of 3a with that of 1d, resulting in a structure of printing/indicia, polyethylene, acrylic adhesive, a die cut hole in the center of the Q that aligns with the stripe of 1d, paper with an indicator stripe, patterned adhesive (no adhesive in the indicator stripe areas), release agent and liner.
c) Die cut the rectangular labels down to the release liner.
   Equivalents

Those skilled in the art will recognize, or be able to ascertain using no more than routine experimentation, numerous equivalents to the specific procedures described herein. Such equivalents are considered to be within the scope of the invention. Various substitutions, alterations, and modifications may be made to the invention without departing from the spirit and scope of the invention. Other aspects, advantages, and modifications are within the scope of the invention. The contents of all references, issued patents, and published patent applications cited throughout this application are hereby incorporated by reference. The appropriate components, processes, and methods of those patents, applications and other documents may be selected for the invention and embodiments thereof.

What is claimed is:

1. AN FQI comprising, in turn:
a) an impervious layer having at least one non-impervious region;
b) a porous substrate layer having at least one region containing an indicator composition which changes color in response to compounds characteristic of decomposing food; and
c) an adhesive layer having at least one region allowing fluid communication through the porous substrate layer,
wherein at least one non-impervious region(s), the indicator region(s) and one region of the adhesive layer allowing fluid communication overlay each other to form an indicator region allowing for fluid communication across the porous substrate, which indicator region allows for visual indication of the state of spoilage.

2. The FQI of claim 1, further comprising a release sheet adhering to the adhesive layer.

3. The FQI of claim 1, wherein the indicator composition is selected from the group consisting of cabbage powder extract, beet extract, anthocyanins, anthocyanidins, flavonoids, betalain and betalain derivatives.

4. The FQI of claim 1, wherein the indicator composition is color-sensitive for the presence of amines.

5. The FQI of claim 1, wherein the adhesive layer is a patterned adhesive.

6. The FQI of claim 5, wherein the patterned adhesive layer is a printed dot pattern.

7. The FQI of claim 5, wherein the patterned adhesive layer is an alternating stripe pattern.

8. The FQI of claim 5, wherein the patterned adhesive layer is a border or concentric circular pattern.

9. The FQI of claim 1, wherein the non-impervious region comprises an opening in the impervious layer.

10. The FQI of claim 1, wherein the indicator composition is color-sensitive for the presence of acids.

11. The FQI of claim 1, wherein the porous substrate is selected from the group consisting of cellulosic materials and polymeric membranes.

12. The FQI of claim 1, wherein the porous substrate has a pH<7.

13. The FQI of claim 1, wherein the pH of the porous substrate is between 6 and 7.

14. The FQI of claim 1, wherein the porous substrate does not undergo an acid base reaction with the indicator.

15. The FQI of claim 1, wherein the patterned adhesive is selected from the group consisting of pressure sensitive adhesives, acrylic based adhesives and ultraviolet cured adhesives.

16. The FQI of claim 1, wherein the impervious composition is selected from the group consisting of polyethylene, polyolefin, polyester, polypropylene and acrylic.

17. The FQI of claim 1, wherein the impervious composition further comprises indicia that cooperate with the indicator region to provide a reference color for comparison with the color of the indicator region.

18. The FQI of claim 17, wherein the indicia further includes instructions for use.

19. The FQI of claim 17, wherein the indicia further indicates whether the indicator has been activated.

20. The FQI of claim 1, further comprising a continuous adhesive layer interposed between the impervious layer and the porous substrate.

21. The FQI of claim 1, further comprising a removable cover layer over the impervious layer.

22. The FQI of claim 1, further comprising a hydrophobic, breathable or gas-permeable, cover layer over the impervious layer.

23. The FQI of claim 21, wherein the removable cover layer displays indicia showing that the device is not activated and the impervious layer displays indicia showing that the device is activated, wherein the indicia on the impervious layer is at least partially invisible when the removable cover layer is in place.

24. A food package comprising a food product; and a gas-permeable wrap and the FQI of claim 1 affixed thereto.

25. A method of monitoring food quality in a sealed package, comprising:
a) providing a food package containing a food product; and a gas-permeable wrap;
b) affixing an FQI to the gas-permeable wrap, wherein the FQI comprises an impervious layer having at least one non-impervious region; a porous substrate layer having at least one region containing an indicator composition which changes color in response to compounds characteristic of decomposing food; and an adhesive layer having at least one region allowing fluid communication through the porous substrate layer, wherein at least one non-impervious region(s), the indicator region(s) and one region of the adhesive layer allowing fluid communication overlay each other to form an indicator region allowing for fluid communication across the porous substrate, which indicator region allows for visual indication of the state of spoilage; and
c) visually inspecting the FQI to determine the quality of the food product based on the color of the FQI.

26. The method of claim 25, wherein the visual inspection step further comprises comparing the color of the FQI in reference to a color region displayed on the impervious layer.

27. A method of manufacturing a laminated FQI comprising the steps of:
a) providing a porous substrate layer;
b) laminating an adhesive pattern to one surface of the porous substrate layer, where the pattern includes regions where adhesive is not applied;
c) providing an impervious layer for lamination to the non-adhesive surface of the porous substrate layer, the impervious layer having at least one non-impervious region;
d) laminating an impervious layer to the non-adhesive surface of the porous substrate layer so the non-impervious region(s) are situated over the non-adhesive regions of the porous substrate layer of step b);
e) applying to the non-adhesive region(s) of the porous substrate layer an indicator composition which changes color in response to compounds characteristic of decomposing food; and
f) laminating a release sheet to the adhesive surface of the porous substrate layer.
